(19) United States
(12) Patent Application Publication
(10) Pub. No.: US 2026/0286113 A1
(43) Pub. Date: Sep. 24, 2026

(54) NON-FLUORINATED POLYMER PROCESS AIDS

(71) Applicant: NOVA CHEMICALS (INTERNATIONAL) S.A., Fribourg (CH)

(72) Inventors: Josh HEIDEBRECHT, Calgary (CA); Tony TIKUISIS, Calgary (CA); Derek WASYLENKO, Calgary (CA); Jared TAYLOR, Calgary (CA)

(73) Assignee: NOVA CHEMICALS (INTERNATIONAL) S.A., Fribourg (CH)

(21) Appl. No.: 19/489,328

(22) PCT Filed: Jun. 11, 2024
(86) PCT No.: PCT/IB2024/055708

§ 371 Date: Dec. 2, 2025

Related U.S. Application Data
(60) Provisional application No. 63/521,308, filed on Jun. 15, 2023.

(51) Int. Cl. C08L 23/08; B29C 49/04; B29K 23/00; B29K 71/00; B29K 77/00; B29L 7/00

(52) U.S. Cl. CPC C08L 23/08; B29C 49/04; B29K 2023/0625; B29K 2071/02; B29K 2077/00; B29L 2007/008; C08L 2203/16; C08L 2205/06; C08L 2205/08; C08L 2207/066

(57) ABSTRACT

A polymeric composition and methods of making and using the same that includes a polyolefin polymer and 100 ppm to 10,000 ppm of a polyamide is disclosed. The composition can be substantially free of a polyolefin polymer/polyamide compatibilizer.

### TECHNICAL FIELD

The invention generally concerns polyolefin (e.g., polyethylene) compositions. The compositions can include a non-fluorinated polymer process aid (PPA) and can be substantially free of or free of fluorinated PPAs. The compositions can have improved melt fracture characteristics when compared with compositions that include fluorinated PPAs.

### BACKGROUND ART

Extruded polymers (e.g., blown polyethylene films) can exhibit surface defects that look like sharkskin, snakeskin, and/or orange peel. These surface defects are typically referred to as “melt fracture”. Melt fracture in extruded polymer compositions can cause a reduction in physical properties, hazy appearance, printing issues, and/or sealing issues in the resulting produced article. Melt fracture is believed to result when the shear rate at the surface of the polymer composition is sufficiently high that the surface of the polymer composition begins to fracture. That is, there is a slippage of the surface of the extruded polymer composition relative to the body of the polymer composition. The surface generally cannot flow fast enough to keep up with the body of the extrudate and a fracture in the melt occurs generally resulting in a loss of surface properties for the extrudate. Melt fracture is theorized to result from a velocity gradient of the polymer composition in the extruder due to friction on the extruder surfaces. This velocity gradient can lead to a “slip-stick” phenomenon as the melt exits the die, causing the surface irregularities or melt fractures.

A current solution for preventing melt fracture is the use of low levels (~0.1 wt. %) of high molecular weight fluoro-containing compounds, such as, for example, fluoropolymer or fluoroelastomer copolymers of vinylidene difluoride and hexafluoropropylene. These additives coat the surface of the extruder and die to prevent sticking and allow for significantly higher processing rates to avoid the onset of melt fracture.

While attempts have been made to use PPAs other than fluoro-containing additives, use of these PPAs can be complicated to use, costly, and/or can still result in melt fracture issues. By way of example, U.S. Patent Application Publication No. 2023/0031000 to Ruocco et al., describes a PPA that is blend of at least two of a polyethylene glycol, a surfactant comprising a sorbitan ester or a polysorbate, and a metal salt of a fatty acid. Such a blend can be costly, and introduction of a multitude of components into the polymer resin can affect the properties of the resin. As another example, U.S. Patent Application Publication No. 2023/0036922 to Leaf et al., discloses the use of polyethylene glycol (PEG)-based polymer processing aids. PEGs can have a relatively slow melt fraction elimination when compared with fluoro-containing PPAs.

### SUMMARY OF INVENTION

A discovery has been made that provides a solution to at least one or more of the problems associated with replacing fluoro-containing PPAs and reducing melt fracture issues in extruded polyolefin compositions. In one aspect, the solution can include the use of a polyamide (e.g., a polylactam such as, for example, nylon-based polylactams) as a PPA. It was discovered that the use of polyamides can have improved melt fracture properties (reduced melt fracture issues) when compared with fluoro-containing PPAs (e.g., high molecular weight fluoropolymer or fluoroelastomer copolymers of vinylidene difluoride and hexafluoropropylene). In one non-limiting example, it was discovered that the use of polyamide 6 homopolymer (Nylon 6) in linear low-density polyethylene (LLDPE) based compositions performs better than known fluoro-containing PPAs in reducing melt fraction issues when the compositions are extruded into blown films. In another non-limiting example, it was discovered that the use of polyamide 6/6,6 copolymer (Nylon 6/6,6) in linear low-density polyethylene (LLDPE) based compositions performs better than known fluoro-containing PPAs in reducing melt fraction issues when the compositions are extruded into blown films. This discovery can be advantageous to the environment, for example, by providing an effective alternative to the use of fluoro-containing PPAs for polyolefin compositions. It can also be advantageous in further reducing melt fracture issues with extruded polymer compositions. In one aspect of the present invention, the polyolefin compositions of the present invention can be substantially free of or free of fluoro-containing PPAs and/or compounds with minimal or no melt fracture issues when extruded (e.g., into blown films).

It was also discovered that the polymeric compositions of the present invention can be substantially free of (e.g., 2 wt. % or less, 1 wt. % or less, 0.5 wt. % or less, 0.1 wt. % or less, or 0.01 wt. % or less) or free of polyolefin polymer/polyamide (e.g., polylactam) compatibilizers (e.g., maleic anhydride containing compounds and/or polymers or copolymers of a polyolefin bound to a polar polymer) and still maintain their improved melt fracture properties. This discovery can be advantageous, for example, in that a polyamide (or combination of polyamides) can be used as the sole PPA and can serve to reduce melt fracture issues, which can reduce the costs and/or complexities of the resulting polymeric compositions.

In one aspect of the present invention, polymeric compositions are described. A polymeric composition can include a polyolefin polymer and 100 ppm to 10,000 ppm of a polyamide (e.g., a polylactam such as a nylon-based polymer). The polymeric composition can include 100 parts per million (ppm) or be substantially free of (e.g., less than 50 ppm, preferably less than 40, 30, 20, 10, 5, 4, 3, 2, or 1 ppm) or free of (0 wt. %) a fluoro-containing PPA(s) (e.g., high molecular weight fluoropolymer or fluoroelastomer copolymers of vinylidene difluoride and hexafluoropropylene). The polymeric composition can be substantially free of (e.g., 2 wt. % or less, 1 wt. % or less, 0.5 wt. % or less, 0.1 wt. % or less, or 0.01 wt. % or less) or free of (0 wt. %) of a polyolefin polymer/polyamide compatibilizer (e.g., maleic anhydride, polyethylene maleic anhydride, grafted polypropylene, maleic anhydride grafted polypropylene, maleic anhydride ethylene, a co-polymer of a polyolefin bound to a polar polymer or combinations thereof). In some aspects, the polymeric composition can include 100 ppm to 1 wt. % of a polyethylene glycol and additives (e.g., antioxidant, an ultra-violet stabilizer, or both). In some specific aspects, the polymeric composition can include: (1) 98 wt. % to 99.9 wt. % of the polyolefin polymer; 200 to 2,000 ppm of polyamide; and 0 to 1 wt. % additives; (2) 99 wt. % to 99.9 wt. % of the polyolefin polymer, 500 to 1,000 ppm of polyamide, and 0 to 1 wt. % additives; or (3) 99.5 wt. % to 99.9 wt. % of the polyolefin polymer, 600 to 800 ppm of polyamide, and 0 to 1 wt. % additives. The polymeric composition can be substantially free of (e.g., 2 wt. % or less) or free of a polyolefin polymer/polyamide compatibilizer. The polymeric composition of the present invention can have an weight average molecular weight, Mw greater than 2,500 g/mol (Da) to 250,000 g/mol (Da). In some aspects, the polymeric composition can have a time to clear a melt fracture of less than 50 minutes as measured on a blown film line. In one instance, the melt fracture can be measured using a Little Macro blown film line as described in Example 2. The polymeric composition of the present invention can be in a form of a pellet, a powder, a molded part, or a film. In some aspects, the polymeric composition can be an extrusion molded article, an injection molded article, a compression molded article, a rotational molded article, a blow molded article, an injection blow molded article, a 3-D printed article, a thermoformed article, a foamed article, a blown film, a cast film, or a writeable film. Notably, the polymeric composition can be free of, substantially free of, or includes less than 100 ppm of a fluoro-based compound. Non-limiting examples of fluoro-based compounds can include fluoropolymer, fluoroelastomers, or combination thereof.

In some aspects, the polyolefin can include a polyethylene. The polyethylene can be a copolymer of ethylene with at least one alpha olefin selected from 1-butene, 1-hexene, 4-methyl 1-pentene, or 1-octene. In some aspects, polyethylene can have a melt index (MI2) of 0.1 to 10 grams per 10 minutes and a density of 0.88 to 0.970 g/cm³, a melt index (MI2) of 0.1 to 10 grams per 10 minutes and a density of 0.93 to 0.970 g/cm³, or a melt index (MI2) of 0.1 to 10 grams per 10 minutes and a density of 0.88 to 0.94 g/cm³. In one aspect of the present invention, the polyolefin can be linear low-density polyethylene (LLDPE). The LLDPE can have a MI2 of 0.85 g/10 min and a density of 0.913 g/cm³. The LLDPE can have a MI2 of 0.85 g/10 min and a density of 0.914 g/cm³. In an aspect of the invention, the polyamide can comprise a polylactam such as a polycaprolactam homopolymer (e.g., polyamide 6 homopolymer (Nylon 6)). In an aspect of the invention, the polyamide can comprise a polylactam, including a polylactam copolymer such as a polycaprolactam copolymer (e.g., polyamide 6/6,6 copolymer (Nylon 6/6,6)). The polyolefin/polyamide compatibilizer can be present from 0 wt. % to less than 1 wt. %, preferably from 0 wt. % to less than 0.1 wt. %, or more preferably from 0 wt. % to less than 0.01 wt. %, based on the total weight of the polyolefin composition.

Methods of producing the polymeric composition are also described. A method can include melt compounding the polyolefin (e.g., polyethylene) and the polyamide (e.g., polylactam such as a polycaprolactam) to produce a mixture. The mixture can be extruded to obtain the polymeric composition. Extruding can include a blown film extrusion process at a temperature of 180° C. to 275° C.

In some embodiments, methods of reducing melt fractures in an extruded polyolefin composition are described. A method can include adding 100 ppm to 10,000 ppm of a polyamide to the polyolefin composition prior to extruding the composition. The composition can be substantially free of or free of a polyolefin/polyamide compatibilizer and/or a fluoro-containing compound.

In some embodiments, a polyolefin (e.g., polyethylene) composition of the present invention can be a masterbatch that includes a concentrated amount of the polyamide, additives, or both in the polyolefin. For example, a polyolefin (e.g., polyethylene) composition of the present invention can include, based on the total weight of the polymeric composition: (1) 89 wt. % to 99.5 wt. % (or any range or number therein such as 89, 90, 91, 92, 93, 94, 95, 96, 97, 98, 99, 99.5 wt. %) of the polyolefin polymer (e.g., polyethylene such as linear low density polyethylene, low density polyethylene, or high density polyethylene, preferable linear low density polyethylene); (2) 1 wt. % to 10 wt. % of the polyamide, preferably 5 wt. % to 10 wt. % (or any range or number therein such as 1, 2, 3, 4, 5, 6, 7, 8, 9, or 10 wt. %); and (3) 0 wt. % to 1 wt. % of additive(s) (or any range or number therein such as 0, 0.1, 0.2, 0.3, 0.4, 0.5, 0.6, 0.7, 0.8, 0.9, or 1 wt. %). The polyolefin composition can be substantially free of (e.g., 2 wt. % or less) or free of (0 wt. %) a polyolefin polymer/polyamide compatibilizer.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

The term “masterbatch” refers to a concentrated mixture of polyamide, additives, or a combination thereof in a polyolefin carrier.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, which includes the component. In a non-limiting example, 10 grams of component in 100 grams of the material is 10 wt. % of component.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising”, “including”, “containing”, or “having” in the claims, or the specification, may mean “one”, but it is also consistent with the meaning of “one or more,” “at least one”, and “one or more than one”.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The polymeric compositions of the present invention can “comprise”, “consist essentially of”, or “consist of” particular ingredients, components, compositions, etc. disclosed throughout the specification. With respect to the transitional phrase “consisting essentially of”, in one non-limiting aspect, a basic and novel characteristic of the polymeric compositions of the present invention is that they can include a polyamide (e.g., a polylactam such as a polycaprolactam based polymer such as polyamide 6 homopolymer (Nylon 6) or polyamide 6/6,6 copolymer (Nylon 6/6,6)) as a polymer process aid and can be substantially free of or free of fluorinated polymer process aids. The compositions of the present invention can have improved melt fracture properties as compared to polymeric compositions that include fluorinated polymer process aids.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF DRAWINGS

Advantages of the present invention may become apparent to those skilled in the art with the benefit of the following detailed description and upon reference to the accompanying drawings.

FIG. 1 shows melt fracture clearing data on a Little Macro blown film line. C1 is a resin without processing aid (grey diamonds). C2 is a comparative fluoropolymer (black squares). N1 is a non-limiting inventive formulation 1 (dashed line, black circles). N2 is a non-limiting inventive formulation 2 (dashed line, grey squares). N3 is a non-limiting inventive formulation 3 (grey triangles). N4 is a non-limiting inventive formulation 4 (dashed line, black plus symbol).

While the invention is susceptible to various modifications and alternative forms, specific embodiments thereof are shown by way of example in the drawings. The drawings may not be to scale.

### DESCRIPTION OF EMBODIMENTS

A discovery has been made that provides a solution to at least one or more of the problems that may be associated with using fluoro-based polyolefin processing aids in polyolefin compositions. In one aspect, it was discovered that polyamides (e.g., nylon-based polymers (e.g., Nylon 6, or Nylon 6/6,6)) can be used as a polymer process aid and can have better melt fracture properties when compared with fluoro-based polyolefin processing aids. This can allow the polymer compositions of the present invention to be substantially free of (e.g., less than 100 ppm, based on the weight of the polymeric composition) or free of (0 wt. %) fluoro-based polymer process aids.

These and other non-limiting aspects of the present invention are discussed in further detail in the following sections.

### A. POLYMERIC COMPOSITIONS

The polymeric compositions of the present invention can include a polyolefin polymer and a polyamide polymer processing aid. In some aspects, the polymeric compositions of the present invention can include, based on the total weight of the polymeric composition, 98 wt. % to 99.9 wt. % of the polyolefin polymer, 100 to 10,000 ppm of polyamide, and 0 to 1 wt. % additives. In another aspect, the polymeric compositions of the present invention can include 98 wt. % to 99.9 wt. % of the polyolefin polymer, 200 to 2,000 ppm of polyamide, and 0 to 1 wt. % additives. In yet another aspect of the present invention, the polymeric compositions can include 99 wt. % to 99.5 wt. % of the polyolefin polymer, 600 to 800 ppm of polyamide, and 0 to 1 wt. % additives. In other embodiments, the polymeric compositions of the present invention can include a polyglycol. Polymer compositions that include polyglycols can include 97 wt. % to 99.9 wt. % of the polyolefin polymer, 100 to 10,000 ppm of polyamide, 100 to 10,000 ppm of a polyglycol, and 0 to 1 wt. % additives. In other aspects, the polymeric composition can include: (1) 98 wt. % to 99.9 wt. % of the polyolefin polymer; 200 to 2,000 ppm of polyamide; and 0 to 1 wt. % additives; (2) 99 wt. % to 99.9 wt. % of the polyolefin polymer, 500 to 1,000 ppm of polyamide, and 0 to 1 wt. % additives; or (3) 99.5 wt. % to 99.9 wt. % of the polyolefin polymer, 600 to 800 ppm of polyamide, and 0 to 1 wt. % additives.

In another aspect of the present invention, the polymeric composition can include, based on the total weight of the polymeric composition, 89 wt. % to 99.5 wt. % (or any range or number therein such as 89, 90, 91, 92, 93, 94, 95, 96, 97, 98, 99, 99.5 wt. %) of the polyolefin polymer, 1 wt. % to 10 wt. % of the polyamide (or any range or number therein such as 1, 2, 3, 4, 5, 6, 7, 8, 9, or 10 wt. %), and 0 wt. % to 1 wt. % of additive(s) (or any range or number therein such as 0, 0.1, 0.2, 0.3, 0.4, 0.5, 0.6, 0.7, 0.8, 0.9, or 1 wt. %).

The polymeric compositions of the present invention can be substantially free of (e.g., 2 wt. % or less, 1.5 wt. % or less, 1 wt. % or less, 0.5 wt. % or less, 0.1 wt. % or less, or 0.01 wt. % or less) or free of (0 wt. %) a polyolefin/polyamide compatibilizer.

The polymeric compositions of the present invention can include 100 parts per million (ppm) or less or be substantially free of (e.g., 50 ppm or less, preferably less than 40, 30, 20, 10, 5, 4, 3, 2, or 1 ppm) or free of (0 wt. %) a fluoro-containing PPA(s) (e.g., high molecular weight fluoropolymer or fluoroelastomer copolymers of vinylidene difluoride and hexafluoropropylene).

The polymeric compositions of the present invention can have a melt index (MI2) of 0.1 to 10 grams per 10 minutes (e.g., 0.1, 0.5, 1, 1.5, 2, 2.5, 3, 3.5, 4, 4.5, 5, 5.5, 6, 6.5, 7, 7.5, 8, 8.5, 9, 9.5, 10 grams per 10 minutes or any range or value therebetween) and a density of 0.88 to 0.970 g/cm³, (e.g., 0.88, 0.89, 0.9, 0.91, 0.92, 0.93, 0.94, 0.95, 0.96, 0.97 g/cm³ or any value or range therebetween). In some particular aspects, the polymeric compositions can have a melt index (MI2) of 0.1 to 10 grams per 10 minutes and a density of 0.88 to 0.940 g/cm³.

The polymeric compositions of the present invention can be formed into a variety of shapes and/or articles (e.g., pellets, powder, molded parts, films, etc.). A film can have a thickness of 0.001 mm to 1 mm, or 0.001, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1 mm, or any value or range therebetween.

### 1. Polyolefin Polymer

The polyolefin polymer of the present invention can be a thermoplastic polymer. Polyolefins can include those substituted by an aromatic radical (e.g., styrene) or an unsubstituted polyolefin such as polyethylene or a copolymer such as an ethylene alpha olefin copolymer. In some aspects, an olefin polymer (or “polyolefin”) can include at least 85 weight % of one or more C2-3 alpha olefins and up to 15 weight % of one or more C4-8 alpha olefins. Preferably, the polyolefin can include at least 90 weight % of ethylene and up to 10 weight % of one or more C4-8 alpha olefins. Suitable C2-3 alpha olefins include ethylene and propylene. Suitable C4-8 alpha olefins can include butene, 4-methyl pentene, hexene, and octene. An amount of polyolefin in the polymeric composition can range from 97 wt. % to 99.9 wt. %, or 97.1 wt. %, 97.2 wt. %, 97.3 wt. %, 97.4 wt. %, 97.5 wt. %, 97.6 wt. %, 97.7 wt. % 97.8 wt. %, 97.9 wt. %, 98 wt. %, 98.1 wt. %, 98.2 wt. %, 98.3 wt. %, 98.4 wt. %, 98.5 wt. %, 98.6 wt. %, 98.7 wt. %, 98.8 wt. %, 98.9 wt. %, 99 wt. %, 99.1 wt. %, 99.2 wt. %, 99.3 wt. %, 99.4 wt. %, 99.5 wt. %, 99.6 wt. %, 99.7 wt. %, 99.8 wt. % 99.9 wt. % or any range or value therebetween.

The polyolefin can be prepared by conventional processes. In the case of olefins substituted by aromatic radicals such as styrene the polymer can be polymerized in a bulk or solution polymerization initiated either thermally or by free radical polymerization. In the case of unsubstituted olefin polymers, the polymerization can be in gas phase to produce products such as high density (e.g., having a density greater than 0.935, preferably greater than 0.940 g/cc) and low-density polyethylene (having a density from about 0.910 to 0.935 g/cc). Polymerization in the gas phase can include contact monomer(s) with a catalyst in a fluidized bed reactor under polymerization conditions. In some aspects, polymerization conditions include a pressure below 3.4 MPa, preferably below about 1.74 MPa, and a temperature below 130° C. Polymerization can also be performed in solution or as a slurry in the presence of a polymerization catalyst (e.g., a coordination catalyst or a metallocene catalysts). Solution polymerization conditions can include temperatures from 130 to 250° C. at atmospheric or low pressures. In a solution process, ethylene and other comonomer(s) can be dissolved in a solvent such as hexane and the presence of a coordination catalyst. Depending on the type of polymerization and the olefin, the olefin polymer may have a weight average Mw from up to 250,000 typically from about 2,500 to 250,000 g/mol (Da). Weight average Mw can be determined using methods known in the art. Non-limiting examples of weight average molecular weight standard methods can include ASTM D6474, ASTM D40001, ISO 16014, and the like.

The invention is useful for thermoplastic polyolefins in general. In a preferred aspect, the invention can improve the extrusion of linear polyethylene, especially linear low-density polyethylene or LLDPE. LLDPE is a copolymer of ethylene with another copolymerizable alpha olefin (e.g., butene, hexene or octene). LLDPE can have a density of less than 0.955 grams per cubic centimeter. Other polyethylenes can be used in the context of the present invention (e.g., low density polyethylene (LDPE) and high-density polyethylene (HDPE)).

Polyolefins can be characterized by density and melt index (MI2). Melt index can be determined using known methods. A non-limiting example of a melt index standard method is ASTM D1238, Condition E, at 190° C. In some aspects, polyethylene used in the present invention can have a melt index (MI2) of 0.1 to 10 grams per 10 minutes (e.g., 0.1, 0.5, 1, 1.5, 2, 2.5, 3, 3.5, 4, 4.5, 5, 5.5, 6, 6.5, 7, 7.5, 8, 8.5, 9, 9.5, 10 grams per 10 minutes or any range or value therebetween) and a density of 0.88 to 0.970 g/cm³, (e.g., 0.88, 0.89, 0.9, 0.91, 0.92, 0.93, 0.94, 0.95, 0.96, 0.97 g/cm³ or any value or range therebetween). For example, the polyethylene can have a melt index (MI2) of 0.1 to 10 grams per 10 minutes and a density of 0.93 to 0.970 g/cm³. In yet another example, the polyethylene can have a melt index (MI2) of 0.1 to 10 grams per 10 minutes and a density of 0.88 to 0.94 g/cm³. In some aspects, LLDPE is used. LLDPE of the present invention can have a density of from 0.900 to 0.950 g/cm³ (e.g., 0.9, 0.91, 0.92, 0.93, 0.94, 0.95 g/cm³ and any value or range therebetween) and a MI2 of from 0.3 to 5.0 grams/10 minutes (e.g., 0.3, 0.5, 1, 1.5, 2, 2.5, 3, 3.5, 4, 4.5, 5 grams/10 minutes or any range or value therebetween). In specific aspects, the LLDPE has a MI2 of 0.80 to 0.9 g/10 min and a density of 0.910 to 0.915 g/cm³, or a MI2 of 0.85 g/10 min and a density of 0.913 g/cm³, or a MI2 of 0.85 g/10 min and a density of 0.914 g/cm³. The density of a polyolefin may be determined using ASTM D792-13 (Nov. 1, 2013).

### 2. Polyamides

The polymeric compositions of the present invention can include a polyamide. Polyamides are polymers which contain repeating amide (—CO—NH—) linkages. Polyamides are typically condensation copolymers formed by reaction of dicarboxylic acids with diamines or by ring opening of lactams. Various polyamides can be created by adjusting the number of carbons.

In a particular embodiment of the present invention, the polyamide can include polylactams, such as polycaprolactam, which are a family of synthetic aliphatic thermoplastic resins, produced via ring-opening polymerization of cyclic amides (lactams).

Non-limiting examples of polylactams include nylons that are homopolymers, dyadic homopolymers, or copolymers thereof. Homopolymer polylactams can have the following general formula [NH—(CH₂)ₓ—CO]ₙ where x is 4 to 25 and n is the repeating number of the polymer (e.g., 3 to 20). Dyadic homopolymers can have the general formula [NH—(CH₂)ₓ—NH—CO—(CH₂)_{y}—CO]ₙ where x is 4 to 12, y is 4 to 12 and n is the repeating number of the polymer (e.g., 3 to 20).

Non-limiting examples of nylons (or polyamides) that can be used in the context of the present invention include poly(4-aminobutyric acid) (nylon 4), poly(6-aminohexanoic acid) (nylon 6, also known as poly(caprolactam)), poly(7-aminoheptanoic acid) (nylon 7), poly(8-aminooctanoic acid) (nylon 8), poly(9-aminononanoic acid) (nylon 9), poly(10-aminodecanoic acid) (nylon 10), poly(11-aminoundecanoic acid) (nylon 11), nylon 4,6, poly(hexamethylene adipamide) (nylon 6,6), poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12) and the like. Non-limiting examples of polyamide copolymers which can be used in the context of the present invention include caprolactam/hexamethylene adipamide copolymer (nylon 6,6/6), hexamethylene adipamide/caprolactam copolymer (nylon 6/6,6), trimethylene adipamide/hexamethylene azelaiamide copolymer (nylon trimethyl 6,2/6,2), hexamethylene adipamide-hexamethylene-azelaiamide caprolactam copolymer (nylon 6,6/6,9/6) and the like. In some preferred aspects of the present invention, nylon 6, nylon 6,6, nylon 6/6,6 as well as mixtures of the same can be used. In particular embodiments, nylon 6 is preferred. In particular embodiments, nylon 6/6,6 is preferred. In particular embodiments, nylon 6,6/6 is preferred.

In an aspect, the polyamide is polyamide 6 homopolymer, also known as polycaprolactam or nylon 6.

In an aspect, the polyamide is polyamide 6/6,6 copolymer, also known as nylon 6/6,6.

In some aspects, the polyamide can have a melting point of 215° C. to 225° C. and a density of 1.0 to 1.5 g/cm³, preferably a density of 1.1 to 1.2 g/cm³. In some aspects, the polyamide can have a melting point of 185° C. to 215° C. and a density of 1.0 to 1.5 g/cm³, preferably a density of 1.1 to 1.2 g/cm³. Nylons can be obtained from commercial manufacturers. A non-limiting example of nylon manufactures include UBE corporation, Europe, S.A.U. (Spain), Lanxess (Germany) BASF SE (USA), Huntsman International LLC (USA), Domo Chemicals (Italy), TORAY, Industries, Inc. (Japan).

The amount of polyamide (based on the total weight of the polymeric composition) can be range from 100 to 10,000 ppm, or 100 ppm, 500 ppm, 1,000 ppm, 1,500 ppm, 2,000 ppm, 2,500 ppm, 3,000 ppm, 3,500 ppm, 4,000 ppm, 4,500 ppm, 5,000 ppm, 5,500 ppm, 6,000 ppm, 6,500 ppm, 7,000 ppm, 7,500 ppm, 8,000 ppm 8,500 ppm, 9,000 ppm, 9,500 ppm, 10,000 ppm or any range or value therebetween. In further aspects, an amount of polyamide (e.g. a polyamide comprising a polylactam such as polycaprolactoam) based on the total weight of the polymeric composition can be 700 ppm, to 800 ppm, or around 750 ppm. In still further aspects, an amount of polyamide (e.g. a polyamide comprising a polylactam such as polycaprolactoam) based on the total weight of the polymeric composition can be 1,250 ppm, to 1,750 ppm, or about 1,500 ppm. In an aspect, an amount of polyamide (e.g. a polyamide comprising a polylactam such as polycaprolactoam) based on the total weight of the polymeric composition can be 500 ppm, to 2,000 ppm, or can be 500 ppm, to 1,750 ppm, or can be 650 ppm, to 1,750 ppm.

### 3. Polyglycol

In some aspects of the present invention, the polymeric composition can include a polyglycol as an additional processing aid additive. In aspects, the polyglycol has a weight average molecular weight of 2,000 g/mol, to 50,000 g/mol, or from 3,000 g/mol to 3,500 g/mol. Non-limiting examples of polyglycols include polyethylene glycols, PEG ethers, polypropylene glycols, polytetrahydrofurans and mixtures thereof. Ethers of PEG include lauryl, cetearyl, cetyl, stearyl, oleyl ethers, or mixtures thereof. A non-limiting example of a suitable PEG is commercially available under the trademark Polyglykol from Clariant Ltd. The amount of polyglycol (based on the total weight of the polymeric composition) can be range from 100 to 10,000 ppm, or 100 ppm, 500 ppm, 1,000 ppm, 1500 ppm, 2,000 ppm, 2,500 ppm, 3,000 ppm, 3,500 ppm, 4,000 ppm, 4500 ppm, 5,000 ppm, 5,500 ppm, 6,000 ppm, 6,500 ppm, 7,000 ppm, 7,500 ppm, 8,000 ppm 8,500 ppm, 9,000 ppm, 9,500 ppm, 10,000 ppm or any range or value therebetween. In an aspect, an amount of PEG based on the total weight of the polymeric composition can be 500 ppm, to 2,500 ppm. In an aspect, an amount of PEG based on the total weight of the polymeric composition can be 700 ppm, to 800 ppm, or about 750 ppm. Optimal addition levels for a given extrusion process may be readily determined by those skilled in the art.

### 4. Polyolefin Polymer/Polyamide Compatibilizers

The polyolefin-containing compositions of the present invention can be substantially free of (e.g., less than 2 wt. %) or free of a polyolefin polymer/polyamide compatibilizer. In certain aspects, the polyolefin-containing compositions can include up to or less than 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2 wt. % of a polyolefin polymer/polyamide compatibilizer, based on the total weight of the composition. In another aspect, the polyolefin-containing composition includes 0 wt. % of a polyolefin polymer/polyamide compatibilizer.

Polyolefin polymer/polyamide compatibilizers include compounds and/or compositions that can stabilize blends of immiscible polymers. Non-limiting examples of polyolefin polymer/polyamide compatibilizers include maleic anhydride, polyethylene maleic anhydride, grafted polypropylene, maleic anhydride grafted polypropylene, maleic anhydride ethylene, a co-polymer of a polyolefin bound to a polar polymer. Non-limiting examples of compatibilizers are found in U.S. Pat. No. 10,100,140. Non-limiting examples of commercial compatibilizers are sold under the tradenames BYNEL® and RETAIN® (Dow Chemical, USA), NOVACOM-P™ (Polygroup, USA), and LICOCENE® (Clariant Plastics & Coatings Ltd., USA).

### 5. Additives

The polyolefin-containing compositions of the present invention can include an additive or multiple additives, fillers, pigments, and the like. Non-limiting examples of additives include an antioxidant, a light stabilizer, an ultra-violet (UV), stabilizer, a polyamide stabilizer, a costabilizer, a nucleating agent, a metal deactivator, a slip agent, or a mixture thereof. The polymeric composition can include an amount of additives, based on the total weight of the composition, of 0 and 1 wt. %, preferably from 0.01 wt. % to 1 wt. %, or between 0.01 wt. % and 1 wt. %, or from 0.01 wt. % to less than 1 wt. %, or between 0.5 wt. % and less than 1 wt. %, or 0 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, or 1 wt. % or any range or value therebetween.

Non-limiting examples of antioxidants include alkylated mono-phenols (also described herein as “hindered phenol primary antioxidants”). Non-limiting examples of hindered phenols include 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4-isobutylphenol; 2,6-dicyclopentyl-4-methylphenol; 2-(alpha.-methylcyclohexyl)-4,6 dimethylphenol; 2,6-di-octadecyl-4-methylphenol; 2,4,6,-tricyclohexyphenol; and 2,6-di-tert-butyl-4-methoxy methylphenol. Suitable hindered phenolic antioxidants which can be used in embodiments of the disclosure, are sold under the trademarks IRGANOX® 1010 (CAS Registry number 6683-19-8) and IRGANOX 1076 (CAS Registry number 2082-79-3) by BASF Corporation.

In some embodiments, antioxidants can include alkylated hydroquinones. Non-limiting examples of alkylated hydroquinones include 2,6-di-tert-butyl-4-methoxyphenol; 2,5-di-tert-butylhydroquinone; 2,5-di-tert-amyl-hydroquinone; and 2,6-diphenyl-4-octadecyloxyphenol.

Other non-limiting examples of antioxidants include thiodiphenyl ethers. Non-limiting examples of thiodiphenyl ethers include: 2,2′-thio-bis-(6-tert-butyl-4-methylphenol); 2,2′-thio-bis-(4-octylphenol); 4,4′-thio-bis-(6-tertbutyl-3-methylphenol); and 4,4′-thio-bis-(6-tert-butyl-2-methylphenol).

In embodiments of the present invention, an antioxidant can include alkylidenebisphenols. Non-limiting examples of alkylidenebisphenols can include 2,2′-methylene-bis-(6-tert-butyl-4-methylphenol); 2,2′-methylene-bis-(6-tert-butyl-4-ethylphenol); 2,2′-methylene-bis-(4-methyl-6-(alpha-methylcyclohexyl) phenol); 2,2′-methylene-bis-(4-methyl-6-cyclohexylphenol); 2,2′-methylene-bis-(6-nonyl-4-methylphenol); 2,2′-methylene-bis-(6-nonyl-4-methylphenol); 2,2′-methylene-bis-(6-(alpha-methylbenzyl)-4-nonylphenol); 2,2′-methylene-bis-(6-(alpha, alpha-dimethylbenzyl)-4-nonyl-phenol); 2,2′-methylene-bis-(4,6-di-tert-butylphenol); 2,2′-ethylidene-bis-(6-tert-butyl-4-isobutylphenol); 4,4′-methylene-bis-(2,6-di-tert-butylphenol); 4,4′-methylene-bis-(6-tert-butyl-2-methylphenol); 1,1-bis-(5-tert-butyl-4-hydroxy-2-methylphenol) butane 2,6-di-(3-tert-butyl-5-methyl-2-hydroxybenzyl)-4-methylphenol; 1,1,3-tris-(5-tert-butyl-4-hydroxy-2-methylphenyl) butane; 1,1-bis-(5-tert-butyl-4-hydroxy-2-methylphenyl)-3-dodecyl-mercaptobutane; ethylene glycol-bis-(3,3,-bis-(3′-tert-butyl-4′-hydroxyphenyl)-butyrate)-di-(3-tert-butyl-4-hydroxy-5-methylphenyl)-dicyclopentadiene; di-(2-(3′-tert-butyl-2′hydroxy-5′methylbenzyl)-6-tert-butyl-4-methylphenyl) terephthalate; and other phenolics such as monoacrylate esters of bisphenols such as ethylidene bis-2,4-di-t-butylphenol monoacrylate ester.

In certain aspects, antioxidants can include benzyl compounds. Non-limiting examples of benzyl compounds include: 1,3,5-tris-(3,5-di-tert-butyl-4-hydroxybenzyl)-2,4,6-trimethylbenzene; bis-(3,5-di-tert-butyl-4-hydroxybenzyl) sulfide; isooctyl 3,5-di-tert-butyl-4-hydroxybenzyl-mercaptoacetate; bis-(4-tert-butyl-3-hydroxy-2,6-dimethylbenzyl)dithiol-terephthalate; 1,3,5-tris-(3,5-di-tert-butyl-4,10 hydroxybenzyl) isocyanurate; 1,3,5-tris-(4-tert-butyl-3-hydroxy-2,6-dimethylbenzyl) isocyanurate; dioctadecyl 3,5-di-tert-butyl-4-hydroxybenzylphosphonate; calcium salt of monoethyl 3,5-di-tertbutyl-4-hydroxybenzylphosphonate; and 1,3,5-tris-(3,5-dicyclohexyl-4-hydroxybenzyl) isocyanurate.

Non-limiting examples of an acylaminophenol antioxidant can include: 4-hydroxy-lauric acid anilide; 4-hydroxy-stearic acid anilide; 2,4-bis-octylmercapto-6-(3,5-tert-butyl-4-hydroxyanilino)-s-triazine; and octyl-N-(3,5-di-tert-butyl-4-hydroxyphenyl)-carbamate.

Non-limiting examples of other antioxidants can include esters of beta-(5-tert-butyl-4-hydroxy-3-methylphenyl)-propionic acid with monohydric or polyhydric alcohols. Non-limiting examples of such compounds include: methanol; diethyleneglycol; octadecanol; triethyleneglycol; 1,6-hexanediol; pentaerythritol; neopentylglycol; tris-hydroxy ethyl isocyanurate; tridiethyleneglycol; and dihydroxyethyl oxalic acid diamide. In embodiments of the disclosure, a primary antioxidant is selected from amides of beta-(3,5-di-tert-butyl-4-hydroxyphenol)-propionic acid, such as for example, N,N′-di-(3,5-di-tert-butyl-4-hydroxyphenylpropionyl)-hexamethylendiamine; N,N′-di-(3,5-di-tert-butyl-4-hydroxyphenylpropionyl)trimethylenediamine; and N,N′-di(3,5-di-tert-butyl-4-hydroxyphenylpropionyl)-hydrazine.

Non-limiting examples of other antioxidants can include phosphites and phosphonites (also described herein as “phosphorus containing secondary antioxidants”), such as, for example, triphenyl phosphite; diphenylalkyl phosphites; phenyldialkyl phosphites; tris (nonyl-phenyl)phosphite [WESTON® 399, available from SI Group]; phosphorous acid, mixed 2,4-bis(1,1-dimethylpropyl)phenyl and 4-(1, 1-dimethylpropyl)phenyl triesters [WESTON 705, CAS Reg. No. 939402-02-5, available from SI Group]; trilauryl phosphite; trioctadecyl phosphite; distearyl pentaerythritol diphosphite; tris(2,4-di-tert-butylphenyl)phosphite [IRGAFOS® 168, available from BASF]; diisodecyl pentaerythritol diphosphite; 2,4,6-tri-tert-butylphenyl-2-butyl-2-ethyl-1,3-propanediol phosphite; bis(2,4-di-tert-butyl-6-methylphenyl)ethyl phosphite [IRGAFOS 38, available from BASF]; 2,2′,2″-nitrilo[triethyltris(3,3′5,5′-tetra-tert-butyl-1,r-biphenyl-2,2′-diyl)phosphite [IRGAFOS 12, available from BASF]; bis(2,4-di-tert-butylphenyl)pentaerythritol diphosphite tristearyl sorbitol triphosphite; tetrakis(2,4-di-tert-butylphenyl)4,4′-biphenylene diphosphonate; 6-[3-(3-tert-butyl-4-hydroxy-5-methylphenyl)propoxy]-2,4,8,10-tetra-tert-butyldibenzo[d,f][1,3,2]dioxaphospepin [SUMILIZER® GP]; bis(2,4,6-tri-tert-butylphenyl)pentaerythritol diphosphate; bis(2,4-dicumylphenyl) pentaerythritol diphosphate; distearyl pentaerythritol diphosphate; diisodecyl pentaerythritol diphosphate; bis(2,4 di-tert-butylphenyl)pentaerythritol diphosphite [ULTRANOX® 626, available from SI Group]; bis(2,6-di-tert-butyl-4-methylpenyl)pentaerythritol diphosphite; bisisodecyloxy-pentaerythritol diphosphite; bis(2,4-di-tert-butyl-6-methylphenyl) pentaerythritol diphosphite; bis(2,4,6-tri-tert-butylphenyl)pentaerythritol diphosphite; tetrakis(2,4-di-tert-butylphenyl)4,4′-bipheylene-diphosphonite [IRGAFOS P-EPQ, available from BASF]; bis(2,4-dicumylphenyl) pentaerythritol diphosphite [DOVERPHOS® S9228-T or DOVERPHOS S9228-CT] and P-EPQ® (CAS Reg. No. 119345-01-6) a commercially available diphosphonate; or a mixture thereof. In embodiments of the disclosure, a secondary antioxidant is selected from DOVERPHOS LGP-11, DOVERPHOS LGP-12 and DOVERPHOS LGP-12LV. In some embodiments, alkylphenol free, polymeric polyphosphites, can be used. Non-limiting examples of which are disclosed in U.S. Pat. No. 8,563,637.

Antioxidants can also include hydroxylamines and amine oxides. Non-limiting examples of hydroxylamines and amine oxides can include N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecy-1-N-octadecylhydroxylamine; N-heptadecyl-N-octadecylhydroxylamine; and N,N-dialkylhydroxylamine derived from hydrogenated tallow amine. The analogous amine oxides are also suitable. A commercially available example of hydroxylamine which may be used in embodiments of the disclosure is the N,N-di(alkyl)hydroxylamine sold as IRGASTAB® 042 (by BASF) and which is reported to be prepared by the direct oxidation of N,N-di(hydrogenated) tallow amine.

In embodiments an antioxidant can include a nitrone. Non-limiting examples of nitrones include N-benzyl-alpha-phenyl nitrone; N-ethyl-alpha-methyl nitrone; N-octyl-alpha-heptyl nitrone; N-lauryl-alpha-undecyl nitrone; N-tetradecyl-alpha-tridecyl nitrone; N-hexadecyl-alpha-pentadecyl nitrone; N-octadecyl-alpha-heptadecylnitrone; N-hexadecyl-alpha-heptadecyl nitrone; N-octadecyl-alpha-pentadecyl nitrone; N-heptadecyl-alpha-heptadecyl nitrone; N-octadecyl-alpha-hexadecyl nitrone; and nitrone derived from N, N-dialkylhydroxylamine derived from hydrogenated tallow amine.

Non-limiting examples of UV absorbers and/or light stabilizers include 2-(2′-hydroxyphenyl)-benzotriazoles, such as, for example, the 5′-methyl-; 3′,5′-di-tert-butyl-; 5′-tert-butyl-; 5′ (1,1,3,3-tetramethylbutyl)-; 5-chloro-3′,5′-di-tert-butyl-; 5-chloro-3′-tert-butyl-5′-methyl-; 3′-sec-butyl-5′-tert-butyl-; 4′-octoxy-3′,5′-di-tert-amyl-; and 3′,5′-bis-(alpha, alpha-dimethylbenzyl) derivatives.

Other UV absorber or light stabilizer can include 2-hydroxy-benzophenones. Non-limiting examples of benzophenones include: the 4-hydroxy-; 4-methoxy-; 4-octoxy; 4-decyloxy-; 4-dodecyloxy-; 4-benzyloxy-; 4,2′,4′-trihydroxy-; and 2′-hydroxy-4,4′-dimethoxy derivative.

In some embodiments, a UV absorber or light stabilizer can be a sterically hindered amines. Non-limiting examples of sterically hindered amines include: bis(2,2,6,6-tetramethylpiperidyl)-sebacate; bis-5 (1,2,2,6,6-pentamethylpiperidyl)-sebacate; n-butyl-3,5-di-tert-butyl-4-hydroxybenzyl malonic acid bis(1,2,2,6,6,-pentamethylpiperidyl) ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylendiamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′ (1,2-ethanediyl)-bis-(3,3,5,5-tetramethylpiperazinone). These amines are typically called HALS (Hindered Amines Light Stabilizing) and include butane tetracarboxylic acid 2,2,6,6-tetramethyl piperidinol esters. Such amines include hydroxylamines derived from hindered amines, such as di(1-hydroxy-2, 2, 6, 6-tetramethylpiperidin-4-yl) sebacate; 1-hydroxy 2,2,6,6-tetramethyl-4-benzoxypiperidine; 1-hydroxy-2, 2, 6, 6-tetramethyl-4-(3,5-di-tert-butyl-4-hydroxy hydrocinnamoyloxy)-piperdine; and N-(1-hydroxy-2, 2,6,6-tetramethyl-piperidin-4-yl)-epsiloncaprolactam. Suitable commercially available HALS which may be used in embodiments of the disclosure include those sold under the trademarks CHIMASSORB® 119; CHIMASSORB 944; CHIMASSORB 2020; TINUVIN® 622 and TINUVIN 770 from BASF, and CYASORB® UV 3346, CYASORB UV 3529, CYASORB UV 4801, and CYASORB UV 4802 from Solvay. In other embodiments, the use of mixtures of more than one HALS are also contemplated.

Other examples of a UV absorber or light stabilizer are substituted and unsubstituted benzoic acids. Non-limiting examples of benzoic acids can include: phenyl salicylate; 4-tertbutylphenyl-salicylate; octylphenyl salicylate; dibenzoylresorcinol; bis-(4-tert-butylbenzoyl)-resorcinol; benzoylresorcinol; 2,4-di-tert-butyl-phenyl-3,5-di-tert-butyl-4-hydroxybenzoate; and hexadecyl-3, 5-di-tert-butyl-4-hydroxybenzoate.

In some embodiments, a UV absorber or light stabilizer can be an acrylates. Non-limiting examples of acrylates can include: alpha-cyano-beta,beta-diphenylacrylic acid-ethyl ester or isooctyl ester; alpha-carbomethoxy-cinnamic acid methyl ester; alpha-cyano-beta-methyl-p-methoxy-cinnamic acid methyl ester or butyl ester; alpha-carbomethoxy-p-methoxy-cinnamic acid methyl ester; and N-(beta-carbomethoxy-beta-cyano-vinyl)-2-methyl-indoline.

Non-limiting examples of co-stabilizers can include melamine; polyvinylpyrrolidone; dicyandiamide; triallyl cyanurate; urea derivatives; hydrazine derivatives; amines; polyurethanes; alkali metal salts and alkaline earth metal salts of higher fatty acids, for example, Ca stearate, calcium stearoyl lactate, calcium lactate, Zn stearate, Mg stearate, Na ricinoleate and K palmitate; antimony pyrocatecholate or zinc pyrocatecholate, including neutralizers such as hydrotalcites and synthetic hydrotalcites; and Li, Na, Mg, Ca, Al hydroxy carbonates. Hydrotalcites which may be used in embodiments of the present invention can, include materials commercially available under the general tradenames DHT-4® (A, C, or V), ZHT-4V® HYCITE® 713, and AC-207™.

Non-limiting examples of nucleating agents can include 4-tert-butylbenzoic acid; adipic acid; diphenylacetic acid; sodium salt of methylene bis-2,4-dibutylphenyl; cyclic phosphate esters; sorbitol tris-benzaldehyde acetal; and sodium salt of bis(2,4-di-t-butylphenyl)phosphate or Na salt of ethylidene bis(2,4-di-t-butyl phenyl)phosphate. Nucleating agents may improve stiffness of a rotomolded part.

In some embodiments, slip agents can be used. Non-limiting examples of slip agents can include oleamide; erucamide; stearamide; and behenamide.

In some aspects, metal deactivators can be used. Non-limiting examples of metal activators can include N,N′-diphenyloxalic acid diamide, N-salicylal-N′-salicyloylhydrazine, N,N′-bis-salicyloylhydrazine, N,N′-bis-(3,5-di-tert-butyl-4-hydrophenylpropionyl)-2-hydrazine, salicyloylamino-1,2,4-triazole, and bis-benzyliden-oxalic acid dihydrazide.

Non-limiting examples of polyamide stabilizers copper salts in combination with iodides and/or phosphorus compounds and salts of divalent manganese.

Other additives can include plasticizers, epoxidized vegetable oils, such as epoxidized soybean oils, lubricants, emulsifiers, pigments, optical brighteners, flameproofing agents, anti-static agents, blowing agents and thiosynergists, such as dilaurythiodipropionate or distearylthiodipropionate.

Non-limiting examples of fillers and reinforcing agents can include calcium carbonate, silicates, glass fibers, asbestos, talc, kaolin, mica, barium sulfate, metal oxides and hydroxides, carbon black, and graphite. If present, then in some embodiments of the present invention, fillers may be incorporated into the thermoplastic polyolefin (e.g., the linear polyethylene) in amounts up to about 50 weight percent, or up to about 30 weight percent, or up to about 20 weight percent, or up to about 10 weight percent (based on the weight of the thermoplastic polyolefin).

### B. METHOD OF MAKING THE POLYMERIC COMPOSITION

The polymeric composition of the present invention can be made using known compounding methodology. For example, all the components may be dry blended in the required weight ratio in a suitable device such as a tumble blender. The resulting dry blend can then be melted in a suitable compounding equipment (e.g., an extruder). In another example, a masterbatch can be prepared with some of the polyolefin and the other ingredients. The masterbatch can then be fed to an extruder and melt blended. In another example, the dry components of the blend may be metered directly into an extruder.

Extruders for thermoplastic polyolefins and extrusion processes which employ these extrudes are well known to those skilled in the art. A typical extruder contains one (or two) flighted screws which rotate within a cylinder or “barrel”. The polyolefin can be sheared between the barrel and the screw by the stresses caused by the rotation of the screw. In addition, the barrel of the extruder may be heated. The shear and/or heat cause the plastic to melt and the action of the flighted screw transports it along the length of the extruder. The molten polyolefin composition extrudate can then be forced through a die to form the desired plastic part. The extruder used for the final extrusion may also be a single or twin-screw extruder. The die may be a slot die or it may be an annular ring die extruding a film of the polymer blend about a stable bubble of air. The film can be collapsed after passing over or about the bubble.

In methods that involve an extruder, the extruder can be a twin or single screw extruder. If it is a twin screw extruder it can be operated in a co-rotating mode (i.e., both screws turning in the same direction) or in a counter rotating mode (i.e., the screws rotate in opposite directions). Specific conditions for operation of any extruder will differ from that of any other extruder. Variations between machines can usually be resolved by non-inventive testing. The extruder can extrude the polymer composition as strands which are then cooled and cut into pellets for subsequent use, typically film extrusion.

For polyolefin compounding, conditions can include temperature and pressure.

Temperatures can range from 180° C. to 275° C., or 180° C., 190° C., 200° C., 210° C., 220° C., 230° C., 240° C., 250° C., 260° C., 270° C., or 275° C. or any value or range therebetween. Pressures can range from 0.1 MPa to 10 MPa or 0.1 MPa, 1 MPa, 2 MPa, 3 MPa, 4 MPa, 5 MPa, 6 MPa, 7 MPa, 8 MPa, 9 MPa, 10 MPa or any value or range therebetween, depending on the compounding method.

For film applications, and in some aspect, pigments or fillers can be excluded, which can result in a clear or relatively clear film. In other applications such as wire and cable (electrical or optical) the polymeric composition can contain a pigment/filler such as carbon black and other adjuvants.

### C. ARTICLES COMPRISING THE POLYMERIC COMPOSITION

Polymeric compositions of the present invention can be shaped into a variety of articles and shapes by using a variety of methods (e.g., injection molding, extrusion molding, rotation molding, foam molding, calendar molding, blow molding, blow-film molding, thermoforming, compaction, melt spinning, and the like). Non-limiting examples of articles include consumer goods, packaging products, pharmaceutical containers, bottles, caps, closures, liners, trash bags, food packaging film and/or materials, laminations, toys, tanks, wire sheathing, cable sheathing, pipes, hoses, or fittings. In some embodiments, the article of manufacture can include printed or written graphics, lettering, or the like. In some preferred aspects, the polymeric compositions can be formed into blow molded films.

Additional non-limiting examples of articles that can be made with the polymer compositions of the present invention include external and/or internal components (e.g., panels, quarter panels, rocker panels, trim, fenders, doors, decklids, trunk lids, hoods, bonnets, roofs, bumpers, fascia, grilles, mirror housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards) for transportation vehicles (e.g., aircraft, automotive, truck, military vehicle (including automotive, aircraft, and water-borne vehicles), scooter, and motorcycle); enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; counter tops; protected graphics; outdoor and indoor signs; enclosures, housings, panels, and parts for automatic teller machines (ATM); computer; desk-top computer; portable computer; lap-top computer; palm-held computer housings; monitor; printer; keyboards; FAX machine; copier; telephone; phone bezels; mobile phone; radio sender; radio receiver; enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; lids for containers; articles made from plastic-wood combinations; golf course markers; utility pit covers; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated painted articles; coated dyed articles; coated fluorescent articles; coated foam articles; and like applications.

Additionally, the polymeric compositions (with or without additives) can also be formed into films or sheets as well as components of stacked polymeric materials (e.g., laminates). The sheet can be a foam sheet, paper sheet, or fabric sheet. Articles include, for example, fibers, sheets, films, multilayer sheets, multilayer films, molded parts, extruded profiles, coated parts and foams, windows, luggage racks, wall panels, chair parts, lighting panels, diffusers, shades, partitions, lenses, skylights, lighting devices, reflectors, ductwork, cable trays, conduits, pipes, cable ties, wire coatings, electrical connectors, air handling devices, ventilators, louvers, insulation, bins, storage containers, doors, hinges, handles, sinks, mirror housing, mirrors, toilet seats, hangers, coat hooks, shelving, ladders, hand rails, steps, carts, trays, cookware, food service equipment, communications equipment and instrument panels.

### D. EXAMPLES

The present invention will be described in greater detail by way of specific examples. The following examples are offered for illustrative purposes only and are not intended to limit the invention in any manner. Those of skill in the art will readily recognize a variety of noncritical parameters which can be changed or modified to yield essentially the same results.

### 1. Example 1 (Preparation of Polymeric Compositions of the Present Invention and Comparative Compositions)

Polymeric compositions of the present invention (N1, N2, N3 and N4) and comparative compositions (C1 and C2) were made by melt compounding the ingredients listed in Table 1 using a Listritz twin-screw pelletizer under the conditions listed in Table 2. The resin used was octene LLDPE VPsK914 (MI2=0.85 g/10 min: density=0.914 g/cm³).

TABLE 1

| Ingredient | N1 | N2 | N3 | N4 | C1 | C2 |
|---|---|---|---|---|---|---|
| AO 1076 | 350 | 350 | 350 | 350 | 350 | 350 |
| | ppm | ppm | ppm | ppm | ppm | ppm |
| AO 168 | 750 | 750 | 750 | 750 | 750 | 750 |
| | ppm | ppm | ppm | ppm | ppm | ppm |
| SUMILIZER GP | 500 | 500 | 500 | 500 | 500 | 500 |
| | ppm | ppm | ppm | ppm | ppm | ppm |
| TINUVIN 622 | 17 | 17 | 17 | 17 | 17 | 17 |
| | ppm | ppm | ppm | ppm | ppm | ppm |
| Fluoropolymer | | | | | | 1,000 |
| (Viton Z110) | | | | | | ppm |
| Nylon 6 | 750 | 1,500 | | | | |
| (UBE Nylon 1030FDX34) | ppm | ppm | | | | |
| Nylon 6/6,6 Copolymer | | | 750 | 1,500 | | |
| (UBE Nylon 5034B) | | | ppm | ppm | | |
| PEG 3350 | 750 | | 750 | | | |
| (Polyglykol 3350P) | ppm | | ppm | | | |
| LLDPE (balance) | 99.69 | 99.69 | 99.69 | 99.69 | 99.8 | 99.74 |
| | wt. % | wt. % | wt. % | wt. % | wt. % | wt. % |

TABLE 2

| Parameter | Units | Value |
|---|---|---|
| Amperage (A) | Amp | 21.5 |
| Nitrogen Purge | L/min | 3.5 |
| Output | kg/h | 15 |
| Pressure (psi) | MPa | 8.6 |
| Temperature - Melt | ° C. | 230 |
| Extruder Speed | rpm | 150 |
| Specific Mechanical Energy | kWkg/h | 0.1735 |

### 2. Example 2 (Melt Fracture Clearing Trials of the Present Invention and Comparative Compositions)

Melt fracture clearing trials were performed on a on Little Macro blown film line using the processing conditions listed in Table 3. A monolayer blown film line equipped with a 3-inch diameter die (manufactured by Macro Engineering & Technology Inc. based in Ontario, CA) was used to determine the effectiveness of the addition of polyamides (e.g. Nylon 6, Nylon 6/6,6) as a polymer processing aid (PPA) in clearing melt defects from an extrudate. The 3-inch Macro blown film line had a standard output of greater than 60 pounds per hour and is equipped with a 15-horsepower motor. The feed-screw had a 1.5-inch diameter and a length/diameter (L/D) ratio of 24/1. The feed-screw is a barrier design and is fitted with a mixing element on the end of the screw. The film bubble is air cooled using chilled air, and the line was operated at a blow-up ratio (BUR) of between 2/1 and 4/1. The blown film line was fitted with a 3-inch diameter annular die and die pin, resulting in a die gap of 35 mil for the experiments. Two die pins were utilized resulting in die gaps of 35 for the experiments.

TABLE 3

| Parameter | Unit | Value |
|---|---|---|
| Blow Up Ratio | — | 2.5 |
| Die Gap | mil | 35 |
| Frost Line Height | inches | 7 |
| Output | lb/h | 65 |
| Film Thickness | mil | 1.5 |
| Shear Rate | s⁻¹ | 460 |

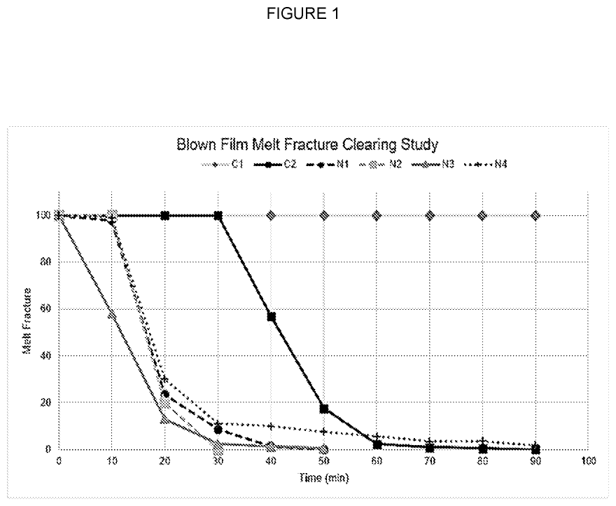

Before the addition of a target thermoplastic composition, the blown film line was purged using a resin containing 30-40% of diatomaceous earth which was free of any polymer processing aids to clean the die by abrasion. Following purging, a PPA free LLDPE with a melt index of 0.8 g/10 min was introduced to produce an extrudate having 100% hard melt fracture across the entire width of the film (e.g., to produce film having gross surface defects with similar appearance to shark skin). Next, the target thermoplastic composition was introduced, and this was recorded as time zero. The target thermoplastic composition was extruded under constant conditions and swatches of the extrudate film were collected every ten minutes to measure melt fracture defects as a percentage of the width of the swatch. The melt extrusion process was continued for 80 minutes for each experiment, and the melt fracture percentage was recorded in ten-minute intervals. The thermoplastic composition extrudate was considered to be clear of melt fracture, when the melt fracture percentage reached zero. The melt fracture clearing data is shown on FIG. 1. Table 4 lists the melt fracture percentages for the samples shown in FIG. 1. C1 does not include a PPA, C2 includes a fluoropolymer, N1 includes a mixture of PEG and polycaprolactam, N2 includes polycaprolactam, N3 includes a mixture of PEG and a high viscosity Polyamide 6/6,6 copolymer, and N4 contains a high viscosity Polyamide 6/6,6 copolymer as the PPAs. From the data of FIG. 1 and Table 4, it is evidenced that the inventive examples (N1, N2, N3 and N4) clear the blown film faster than conventional fluoro-based PPAs (C2).

TABLE 4

| Time | | | | | | |
|---|---|---|---|---|---|---|
| (min) | C1 | C2 | N1 | N2 | N3 | N4 |
| 0 | 100 | 100 | 100 | 100 | 100 | 100 |
| 10 | 100 | 100 | 98 | 100 | 99 | 58 |
| 20 | 100 | 100 | 24 | 20 | 30 | 13 |
| 30 | 100 | 100 | 9 | 0 | 11 | 2 |
| 40 | 100 | 57 | 1 | | 10 | 1 |
| 50 | 100 | 18 | 0 | | 8 | 1 |
| 60 | 100 | 2 | | | 6 | |
| 70 | 100 | 1 | | | 3 | |
| 80 | 100 | 0 | | | 3 | |
| 90 | 100 | 0 | | | 2 | |

Although embodiments of the present application and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

### INDUSTRIAL APPLICABILITY

A polyamide is used as a polymer processing aid to improve the melt extrusion of polyolefins.

1. A polymeric composition comprising:
a polyolefin polymer; and
100 ppm to 10,000 ppm of a polyamide;
wherein the composition is substantially free of a polyolefin polymer/polyamide compatibilizer.

2. The polymeric composition of claim 1, wherein the polyolefin polymer is polyethylene.

3. The polymeric composition of claim 2, wherein the polyethylene polymer is a copolymer of ethylene with at least one alpha olefin selected from butene-1, hexene-1, methyl pentene-1, or octene-1.

4. The polymeric composition of claim 3, wherein the polyethylene polymer has a melt index (MI2) of 0.1 to 10 grams per 10 minutes and a density of 0.88 to 0.970 g/cm³, a melt index (MI2) of 0.1 to 10 grams per 10 minutes and a density of 0.93 to 0.970 g/cm³, or a melt index (MI2) of 0.1 to 10 grams per 10 minutes and a density of 0.88 to 0.94 g/cm³.

5. The polymeric composition of claim 4, wherein the polyolefin polymer is linear low-density polyethylene (LLDPE).

6. The polymeric composition of claim 5, wherein the LLDPE has a MI2 of 0.85 g/10 min and a density of 0.914 g/cm³.

7. The polymeric composition of claim 1, wherein the polyamide comprises a polycaprolactam.

8. The polymeric composition of claim 7, wherein the polyamide is a polyamide 6 homopolymer.

9. The polymeric composition of claim 7, wherein the polyamide is a polyamide 6/6,6 copolymer.

10. The polymeric composition of claim 1, wherein the polymeric composition is free of, substantially free of, or comprises less than 100 ppm of a fluoro-based polymer process aid or aids.

11. The polymeric composition of claim 10, wherein the fluoro-based polymer process aid or aids is a polyvinylidene difluoride, a polyvinylidene fluoride-co-hexafluoropropylene, or a combination thereof.

12. The polymeric composition of claim 1, further comprising 100 ppm to 1 wt. % of a polyethylene glycol.

13. The polymeric composition of claim 1, further comprising an antioxidant, an ultra-violet stabilizer, or both.

14. The polymeric composition of claim 1, wherein the polymeric composition comprises, based on the total weight of the polymeric composition:
98 wt. % to 99.9 wt. % of the polyolefin polymer; 200 to 2,000 ppm of polyamide; and 0 to 1 wt. % additives;
99 wt. % to 99.9 wt. % of the polyolefin polymer, 500 to 1,000 ppm of polyamide, and 0 to 1 wt. % additives; or
99.5 wt. % to 99.9 wt. % of the polyolefin polymer, 600 to 800 ppm of polyamide, and 0 to 1 wt. % additives.

15. The polymeric composition of claim 1, wherein the polyolefin polymer has a weight average molecular weight, Mw greater than 2,500 g/mol (Da) to 250,000 g/mol (Da).

16. The polymeric composition of claim 1, wherein the polymeric composition has a time to clear a melt fracture of less than 50 minutes as measured on a blown film line.

17. The polymeric composition of claim 1, wherein the polymeric composition is in a form of a pellet, a powder, a molded part, or a film.

18. The polymeric composition of claim 1, wherein the polymeric composition is an extrusion molded article, an injection molded article, a compression molded article, a rotational molded article, a blow molded article, an injection blow molded article, a 3-D printed article, a thermoformed article, a foamed article, a blown film, a cast film, or a writeable film.

19. The polymeric composition of claim 1, wherein the polyolefin polymer/polyamide compatibilizer comprises maleic anhydride, polyethylene maleic anhydride, grafted polypropylene, maleic anhydride grafted polypropylene, maleic anhydride ethylene, a co-polymer of a polyolefin joined to a polar polymer, or combinations thereof.

20. The polymeric composition of claim 1, wherein the polymeric composition comprises, based on the total weight of the polymeric composition:
0 to 2 wt. % of the polyolefin polymer/polyamide compatibilizer;
0 to 1 wt. % of the polyolefin polymer/polyamide compatibilizer; or
0 to 0.1 wt. %, of the polyolefin polymer/polyamide compatibilizer.

21. A method of making the polymeric composition of claim 1, the method comprising:
(a) melt compounding the polyolefin polymer and the polyamide to produce a mixture; and
(b) extruding the mixture to obtain the polymeric composition.

22. The method of claim 21, wherein:
the polyolefin polymer is a polyethylene;
the polyamide comprises a polycaprolactam; and
the extruding comprises a blown film extrusion process carried out at a temperature of 180° C. to 275° C.

23. A method of reducing melt fracture in an extruded polymeric composition, the method comprising adding 100 ppm to 10,000 ppm of a polyamide to a polyolefin polymer prior to extruding the resulting polymeric composition, wherein the polymeric composition is substantially free of a polyolefin/polyamide compatibilizer.

24. A polyethylene resin composition comprising:
(a) 89 wt. % to 99 wt. % of a polyethylene;
(b) 1.0 wt. % to 1.0 wt. % of a polyamide; and
(c) 0 wt. % to 1.0 wt. % of additives;
wherein the polyethylene resin composition is substantially free of a polyolefin polymer/polyamide compatibilizer.

25. The polyethylene resin composition of claim 24, wherein the polyethylene resin composition is free of, substantially free of, or comprises less than 100 ppm of a fluoro-based polymer process aid or aids.

26. The polymeric composition of claim 25, wherein the fluoro-based polymer process aid or aids is a polyvinylidene difluoride, a polyvinylidene fluoride-co-hexafluoropropylene, or a combination thereof.
